(19) United States
(12) Patent Application Publication
(10) Pub. No.: US 2014/0218313 A1
(43) Pub. Date: Aug. 7, 2014

(54) ELECTRONIC APPARATUS, CONTROL METHOD AND STORAGE MEDIUM

(71) Applicant: KABUSHIKI KAISHA TOSHIBA, Tokyo (JP)

(72) Inventor: Qi Zhang, Nishitama-gun (JP)

(73) Assignee: KABUSHIKI KAISHA TOSHIBA, Tokyo (JP)

(21) Appl. No.: 13/961,546

(22) Filed: Aug. 7, 2013

Related U.S. Application Data
(63) Continuation of application No. PCT/JP2013/058161, filed on Mar. 21, 2013.

(30) Foreign Application Priority Data
Feb. 7, 2013 (JP) 2013-022078

(51) Int. Cl. G06F 3/0488

(52) U.S. Cl. CPC G06F 3/04883
USPC 345/173

(57) ABSTRACT

According to one embodiment, an electronic apparatus includes a touch screen display and a controller. The touch screen display has a rectangular display area. A rectangular frame is displayed on the display area. The controller is configured to move, if a first touch operation is detected at a display position of a side or a corner of the frame, the side or the corner of the frame to an edge portion of the display area.

### CROSS REFERENCE TO RELATED APPLICATIONS

This application is a Continuation Application of PCT Application No. PCT/JP2013/058161, filed Mar. 21, 2013 and based upon and claiming the benefit of priority from Japanese Patent Application No. 2013-022078, filed Feb. 7, 2013, the entire contents of all of which are incorporated herein by reference.

### FIELD

Embodiments described herein relate generally to a control method of an electronic apparatus including a touch screen display.

### BACKGROUND

In recent years, portable electronic apparatuses such as a tablet terminal and smartphone, which can be driven by a battery, have prevailed. Most of electronic apparatuses of this type include a touch screen display, so as to allow the user to make easy input operations.

The user need only touch an icon or menu displayed on the touch screen display with the finger or pen, thus instructing the electronic apparatus to execute a function associated with that icon or menu.

Then, as for input operations on the electronic apparatus including such touch input (touch device) on the touch screen display, various proposals have been made so far.

When the user wants to select a range on the screen by conventional touch operations, he or she designates a range to be operated by a series of operations by moving a frame indicating a selected range with the finger and changing a size of the frame by dragging a side or corner of the frame with the finger. These operations are popularly made especially in case of screen capture, image trimming, and so forth.

However, such conventional operation method, when the user wants to select a range on the full screen, the operability may lower. More specifically, a deviation between a sensor and line of sight becomes considerably large on an edge portion of the touch screen display, and the center of a touched portion is unwantedly recognized as touch coordinates by a coordinate determination logic, thus making range designation on the full screen difficult.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearance of an electronic apparatus according to an embodiment.

FIG. 2 is an exemplary block diagram showing the system arrangement of the electronic apparatus according to the embodiment.

FIG. 3 is an exemplary first view for explaining an operation principle associated with range designation of a screen capture utility program, which runs on the electronic apparatus according to the embodiment.

FIG. 4 is an exemplary second view for explaining an operation principle associated with range designation of the screen capture utility program, which runs on the electronic apparatus according to the embodiment.

FIG. 5 is an exemplary third view for explaining an operation principle associated with range designation of the screen capture utility program, which runs on the electronic apparatus according to the embodiment.

FIG. 6 is an exemplary fourth view for explaining an operation principle associated with range designation of the screen capture utility program, which runs on the electronic apparatus according to the embodiment.

FIG. 7 is an exemplary fifth view for explaining an operation principle associated with range designation of the screen capture utility program, which runs on the electronic apparatus according to the embodiment.

FIG. 8 is an exemplary sixth view for explaining an operation principle associated with range designation of the screen capture utility program, which runs on the electronic apparatus according to the embodiment.

FIG. 9 is an exemplary seventh view for explaining an operation principle associated with range designation of the screen capture utility program, which runs on the electronic apparatus according to the embodiment.

FIG. 10 is an exemplary flowchart showing the operation sequence of the screen capture utility program, which runs on the electronic apparatus according to the embodiment.

FIG. 11 is an exemplary first view for explaining an application example of range designation by the screen capture utility program, which runs on the electronic apparatus according to the embodiment.

FIG. 12 is an exemplary second view for explaining an application example of range designation by the screen capture utility program, which runs on the electronic apparatus according to the embodiment.

### DETAILED DESCRIPTION

Various embodiments will be described hereinafter with reference to the accompanying drawings.

In general, according to one embodiment, an electronic apparatus includes a touch screen display and a controller. The touch screen display has a rectangular display area. A rectangular frame is displayed on the display area. The controller is configured to move, if a first touch operation is detected at a display position of a side or a corner of the frame, the side or the corner of the frame to an edge portion of the display area.

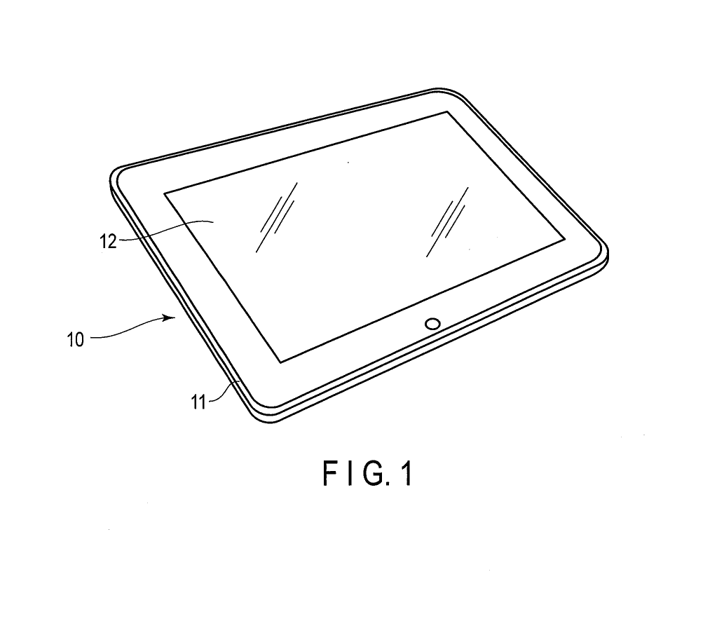

An electronic apparatus of this embodiment can be implemented as, for example, a portable electronic apparatus such as a tablet terminal or smartphone, which allows touch inputs by the finger. FIG. 1 is an exemplary perspective view showing the outer appearance of an electronic apparatus according to this embodiment. As shown in FIG. 1, assume that this electronic apparatus is implemented as a tablet terminal 10 in this case. The tablet terminal 10 includes a main body 11 and touch screen display 12. The touch screen display 12 is attached to be overlaid on the upper surface of the main body 11.

The main body 11 has a low-profile box-shaped housing. In the touch screen display 12, a flat panel display and a sensor configured to detect a ground position of the finger on the screen of the flat panel display are incorporated. The flat panel display is, for example, an LCD (Liquid Crystal Display). The sensor is, for example, a capacitance type touch panel. The touch panel is arranged to cover the screen of the flat panel display.

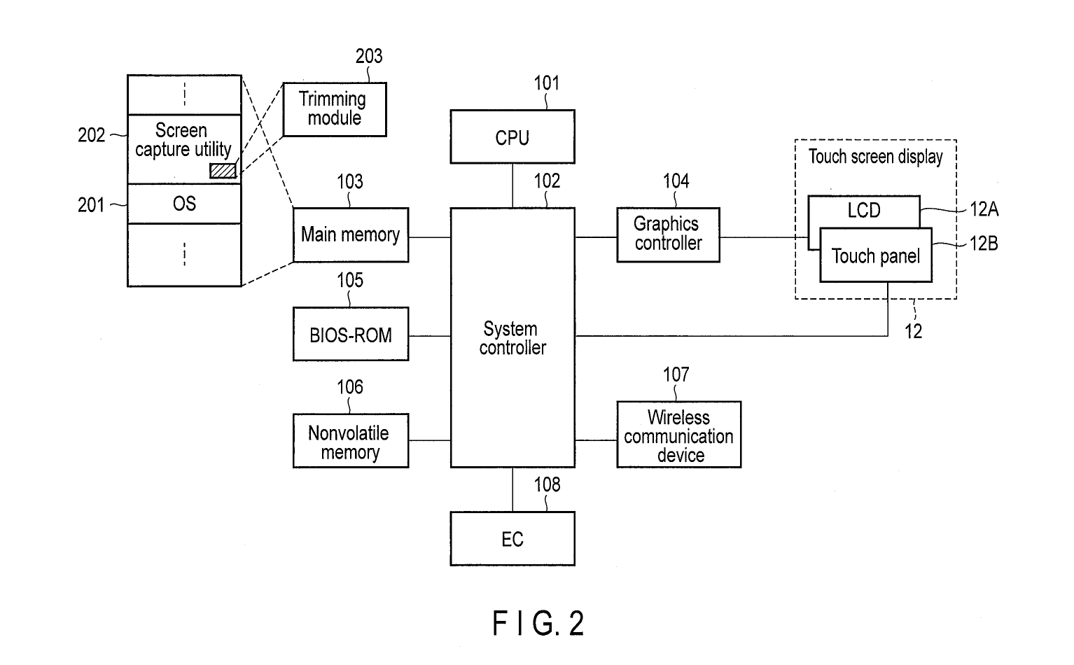

FIG. 2 is an exemplary block diagram showing the system arrangement of the tablet terminal 10.

As shown in FIG. 2, the tablet terminal 10 includes a CPU 101, system controller 102, main memory 103, graphics controller 104, BIOS-ROM 105, nonvolatile memory 106, wireless communication device 107, EC (Embedded Controller) 108, and the like.

The CPU 101 is a processor, which controls operations of various modules in the tablet terminal 10. The CPU 101 executes various software programs loaded from the nonvolatile memory 106 onto the main memory 103. These software programs includes an OS (Operating System) 201 and a screen capture utility program 202 (to be described later). The screen capture utility program 202 includes a trimming module 203.

The CPU 101 also executes a BIOS (Basic Input/Output System) stored in the BIOS-ROM 105. The BIOS is a program required for hardware control.

The system controller 102 is a device used to connect between a local bus of the CPU 101 and various components. The system controller 102 also incorporates a memory controller which controls accesses to the main memory 103. The system controller 102 also includes a function of executing communications with the graphics controller 104 via a PCI EXPRESS serial bus or the like.

The graphics controller 104 is a display controller, which controls an LCD 12A used as a display monitor of the tablet terminal 10. A display signal generated by this graphics controller 104 is sent to the LCD 12A. The LCD 12A displays a screen image based on the display signal. A touch panel 12B is laid out on the LCD 12A. The touch panel 12B is, for example, a capacitance type pointing device used to make inputs on the screen of the LCD 12A. A ground position of the finger on the screen is detected by the touch panel 12B.

The wireless communication device 107 is a device configured to execute wireless communications such as a wireless LAN or 3G mobile communications. The EC 108 is a one-chip microcomputer which includes an embedded controller required for power management. The EC 108 includes a function of turning on/off a power supply of the tablet terminal 10 in response to an operation of a power button by the user.

The screen capture utility program 202, which runs on the tablet terminal 10 having the aforementioned system arrangement, will be described below.

The screen capture utility program 202 is a program required to acquire image data of the screen displayed on the touch screen display 12. For example, when a Web page related to a certain event is displayed on the touch screen display 12 by a Web browser, the screen capture utility program 202 can save a displayed portion of that Web page as image data.

Furthermore, the trimming module 203 can designate, as a range, a region to be saved as image data of the display portion of the Web page. For example, when a Web page related to a certain event is displayed on the touch screen display 12 by the Web browser, and a map to that event site is placed on the Web page, the trimming module 203 designates, as a range, the placed portion of the map, thus saving image data of that map.

Then, this tablet terminal 10 improves the operability of touch operations for this range designation on the touch screen display 12, and this point will be described in detail below.

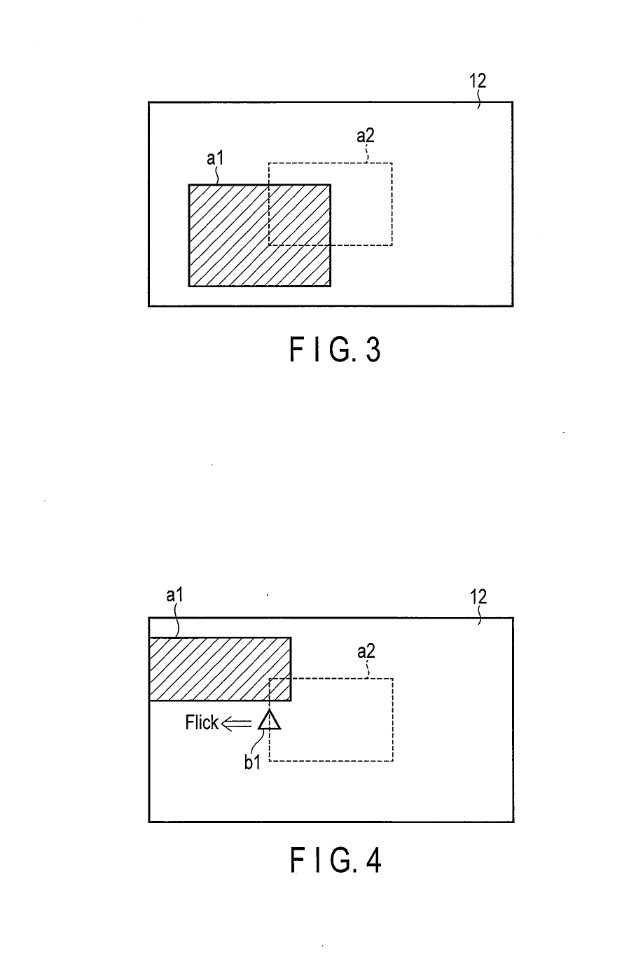

Now assume that the user wants to acquire image data of a region a1 in the screen, which is displayed on the touch screen display 12, as shown in FIG. 3. In this case, the user activates the screen capture utility program 202. The screen capture utility program 202 can be activated by making a touch operation on an icon displayed on, for example, an upper end portion or lower end portion of the touch screen display 12.

After the screen capture utility program 202 is activated, the trimming module 203 displays a frame a2 indicating a selection range at a predetermined position (for example, a central portion) on the touch screen display 12. When the user places and moves the finger within this frame a2, the frame a2 can be moved to that direction. When the user places and moves the finger on a side or corner of the frame a2, a size of the frame a2 can be enlarged or reduced in that direction. The user matches the selection range indicated by the frame a2 with the region a1 by making such touch operations on the touch screen display 12. The user instructs to save image data by, for example, a so-called tap operation within the frame a2.

A case will be assume below wherein one side of the region a1 as an image data acquisition target is located on an edge portion (an end portion of the display surface) of the touch screen display 12, as shown in FIG. 4.

In this case, normally, the user places the finger on a side (at, for example, a position b1 in FIG. 4) on the left side (on the edge portion side of the touch screen display 12) of the frame a2, and then makes a touch operation for sliding that finger to the edge portion of the touch screen display 12.

However, since a deviation between the sensor and line of sight becomes considerably large on the edge portion of the touch screen display 12, and a coordinate determination logic unwantedly recognizes the center of the touched portion as touch coordinates, it is difficult to move the side of the frame a2 to the absolute edge portion. Thus, when the user makes a so-called flick operation toward the side or corner of the display surface of the touch screen display 12 while he or she keeps touching on the side or corner of the frame a2, the trimming module 203 interprets that flick operation as move instruction of the side or corner of the frame a2 to that of the display surface of the touch screen display 12.

The flick operation is not particularly limited as long as the user can make an input operation by moving (sliding) the finger or pen in an arbitrary direction. The flick operation is an input operation when a contact position with an external object moves at a predetermined speed or higher, and the contact with the external object is then lost (that is, the external object is released from the touch screen display 12).

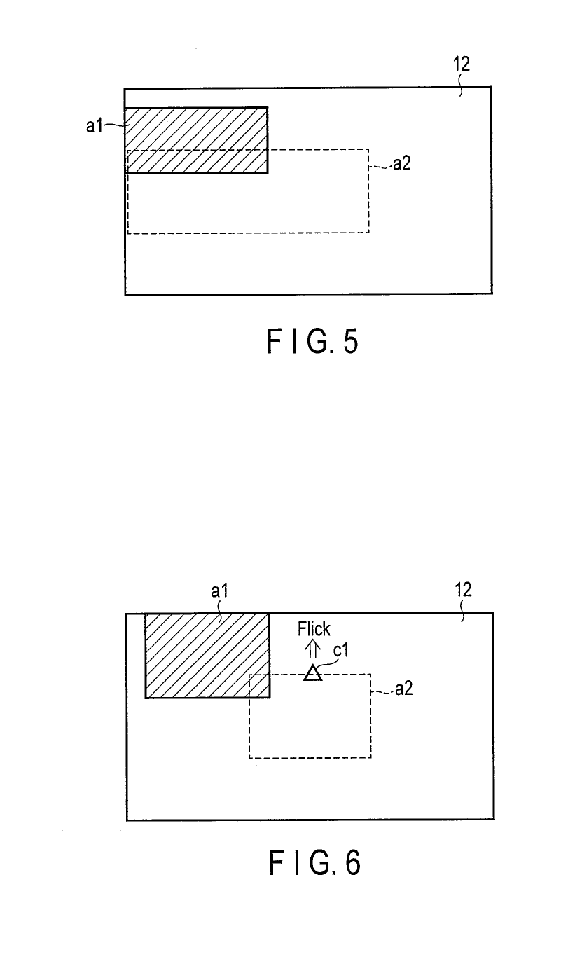

Thus, when the user makes a leftward flick operation on the side of the left side (for example, at the position b1 in FIG. 4) of the frame a2, he or she can easily move the side on the left side of the frame a2 to the left side of the display surface of the touch screen display 12, as shown in FIG. 5. The user moves the remaining three sides to match the selection range indicated by the frame a2 with the region al, and then taps within the frame a2, thereby acquiring image data of the region a1.

Note that the “end portion” when the side or corner of the frame a2 is moved to the end portion of the display surface of the touch screen display 12 in response to the flick operation may perfectly match the side or corner of the display surface of the touch screen display 12 or may be a position inside the side or corner of the display surface of the touch screen display 12 by a given distance. This given distance may be set as, for example, a certain margin. This given distance can be determined based on, for example, the visibility of the side or corner of the frame a2 when the side or corner of the frame a2 is located on the end portion of the display surface of the touch screen display 12, easiness when the user changes the side or corner of the frame a2 again, and the like.

A case will be assumed wherein the upper side of the region a1 is located on the upper side of the display portion of the touch screen display 12, as shown in FIG. 6.

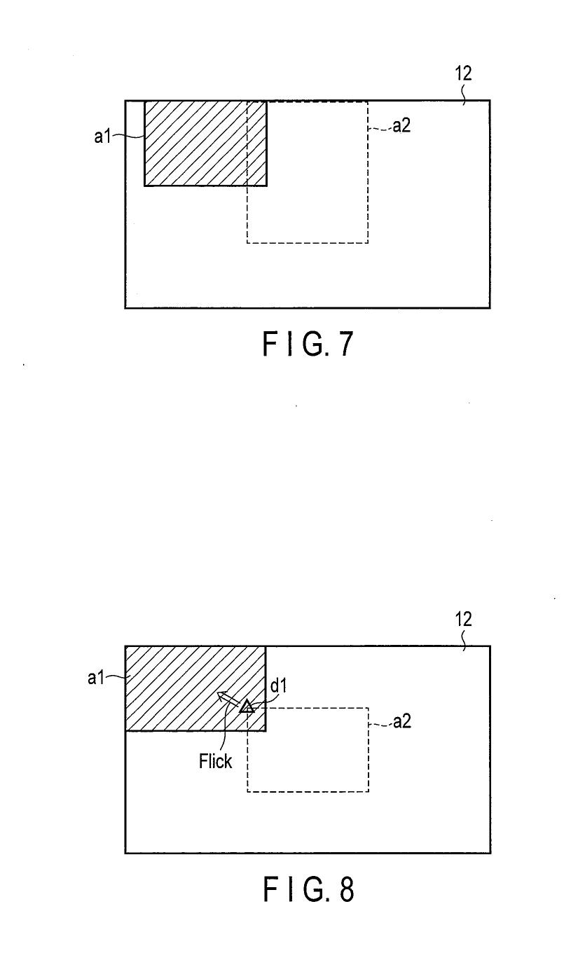

In this case as well, the user makes an upward flick operation on the upper side (for example, at a position c1 in FIG. 6) of the frame a2, thereby easily moving the upper side of the frame a2 to the upper side of the display surface of the touch screen display 12, as shown in FIG. 7. The user moves the remaining three sides to match the selection range indicated by the frame a2 with the region al, and then taps within the frame a2, thereby acquiring image data of the region a1.

Furthermore, a case will be assumed wherein the left side and upper side of the region a1 are located on the left side and upper side of the display portion of the touch screen display 12, that is, the upper left corner of the region a1 is located on that of the display portion of the touch screen display 12, as shown in FIG. 8.

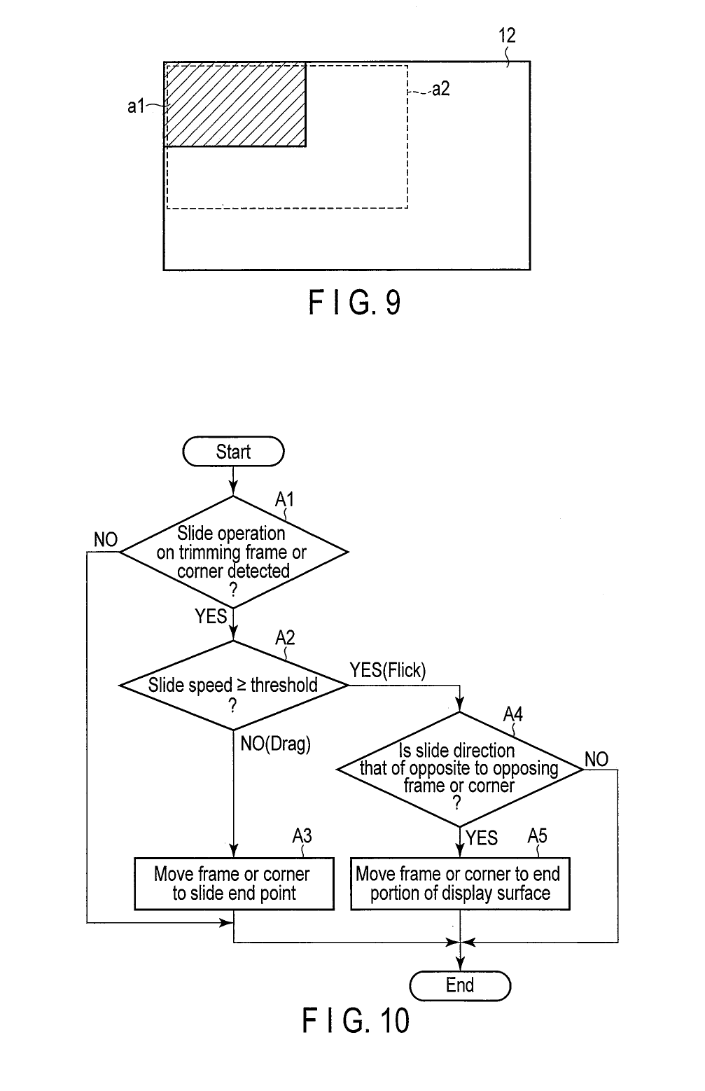

In this case, the user makes an upper-leftward flick operation on the upper left corner (for example, at a position d1 in FIG. 8) of the frame a2. Thus, the upper left corner of the frame a2 can be easily moved to that of the display surface of the touch screen display 12, as shown in FIG. 9. The user moves the remaining three sides to match the selection range indicated by the frame a2 with the region al, and then taps within the frame a2, thereby acquiring image data of the region a1.

In this manner, this tablet terminal 10 can improve the operability of touch operations on the touch screen display 12 (to designate a range).

Note that when the user makes a rightward flick operation on the left side (for example, at the position b1 in FIG. 4) of the frame a2 while the frame a2 is displayed, as shown in, for example, FIG. 4, the trimming module 203 may determine that this flick operation is invalid, or may determine that an instruction to move the left side to the vicinity of the right side is input.

Likewise, when the user makes a lower-rightward flick operation on the upper left corner (for example, at the position d1 in FIG. 8) of the frame a2 while the frame a2 is displayed, as shown in, for example, FIG. 8, the trimming module 203 may determine that this flick operation is invalid, or may determine that an instruction to move the upper left corner to the vicinity of the lower right corner is input.

In this embodiment, assume that the trimming module 203 determines that such flick operation is invalid.

On the other hand, for example, the user may move the side or corner of the frame a2, which has been moved to the end portion of the display surface of the touch screen display 12, to the inner side of the display surface of the touch screen display in some cases. As described above, normally, a touch operation at the end portion of the touch screen display 12 is difficult.

Thus, the trimming module 203 further includes a mechanism for allowing the user to easily make a touch operation for the side or corner located at the end portion of the display surface of the touch screen display 12. More specifically, when the user makes a touch operation within a predetermined distance range from the side or corner of the region al, the trimming module 203 determines that the touch operation is made for that side or corner. Then, the trimming module 203 broadens a distance range as a threshold of the aforementioned determination for the side or corner located at the end portion of the display surface of the touch screen display 12 compared to the sides and corners located at positions other than the end portion of the display surface of the touch screen display 12.

In this manner, this tablet terminal 10 can further improve the operability of touch operations on the touch screen display 12 (to designate a range).

FIG. 10 is an exemplary flowchart showing the operation sequence of the screen capture utility program 202 (trimming module 203).

Upon detection of a slide operation on a trimming frame (on the side of the frame a2) or a corner (on the corner of the frame a2) (YES in block A1), the trimming module 203 determines whether or not the slide speed is not less than a threshold (block A2). If the slide speed is less than the threshold (NO in block A2), the trimming module 203 moves that frame or corner to a slide end point (block A3).

On the other hand, if the slide speed is not less than the threshold (YES in block A2), the trimming module 203 determines whether or not the slide direction is a direction opposite to the opposing frame or corner (block A4). If the slide direction is the direction opposite to the opposing frame or corner (YES in block A4), the trimming module 203 moves that frame or corner to the end portion of the display surface of the touch screen display 12 (block A5).

As described above, this tablet terminal 10 can improve the operability of touch operations using flick operations.

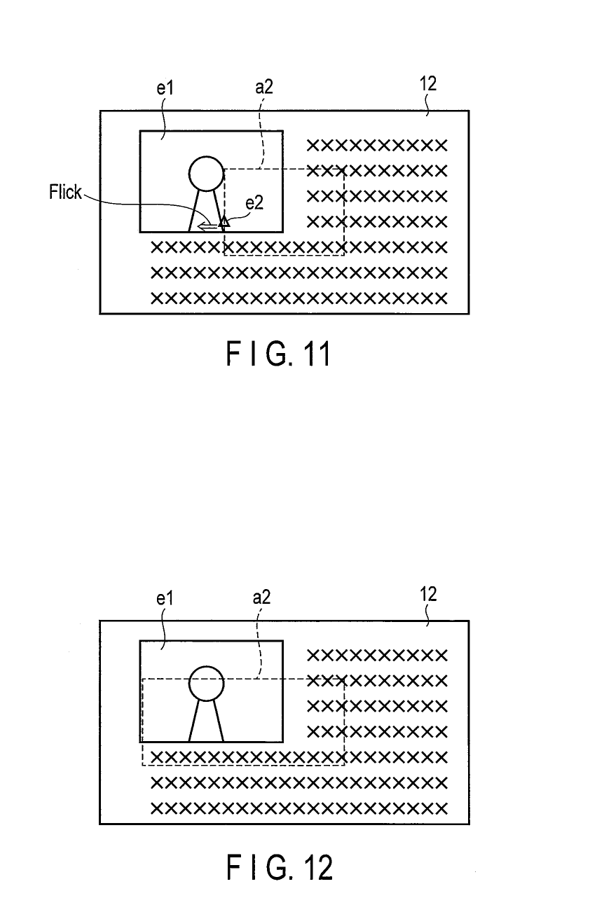

In the aforementioned examples, when the user makes a flick operation for the side or corner of the frame a2, that side or corner is moved to the end portion of the display surface of the touch screen display 12. One application example of the moving method of the side or corner of the frame a2 will be described below with reference to FIGS. 11 and 12.

Now assume that the touch screen display 12 displays a Web page on which an image e1 is laid out, as shown in FIG. 11. Also, assume that the frame a2 is displayed on the touch screen display 12 to partially overlap this image e1.

A case will be examined below wherein the user makes a leftward flick operation on the left side (for example, at a position e2 in FIG. 11) of the frame a2. At this time, the trimming module 203 moves the left side of the frame a2 to the left end of the image e1, as shown in FIG. 12. When the user makes a flick operation again, the trimming module 203 moves the left side of the frame a2 to the left side of the display surface of the touch screen display 12. According to this moving method, the user can easily adjust the selection range indicated by the frame a2 to the image e1.

In the aforementioned examples, range selection for trimming of the screen displayed on the touch screen display 12 has been described. However, the present invention is not limited to this, and the method of the present invention is applicable to range selection in various scenes.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a touch screen display comprising a rectangular display area, a rectangular frame displayed on the display area; and
a controller configured to move, if a first touch operation is detected at a display position of a side or a corner of the frame, the side or the corner of the frame to an edge portion of the display area.

2. The apparatus of claim 1, wherein the first touch operation comprises a flick operation which is detectable if a contact position of a contact on the touch screen display moves at a speed not less than a first speed and then the contact on the touch screen display is lost.

3. The apparatus of claim 2, wherein the controller is configured to move a first side of the frame to an edge portion of a side of the display area in a first direction opposite to a direction of a second side which opposes the first side, when a flick operation is detected at a display position of the first side in the first direction.

4. The apparatus of claim 2, wherein the controller is configured to move a first corner of the frame to an edge portion of a corner of the display area in a second direction opposite to a direction of a second corner which opposes the first corner, when a flick operation is detected at a display position of the first corner in the second direction.

5. The apparatus of claim 1, wherein the controller is configured to move a first side of the frame to an edge portion of a side of the display area in a direction opposite to a direction of a second side which opposes the first side, when a first touch operation is detected at a display position of the first side.

6. The apparatus of claim 1, wherein the controller is configured to move a first corner of the frame to an edge portion of a corner of the display area in a direction opposite to a direction of a second corner which opposes the first corner, when a first touch operation is detected at a display position of the first corner.

7. The apparatus of claim 1, wherein the controller comprises an adjuster configured to move the side or the corner of the frame to a side or a corner of a rectangular image, when the side or the corner of the image displayed to have a size smaller than the display area exists in a direction in which the side or the corner of the frame is moved.

8. The apparatus of claim 1, wherein:
the controller is configured to determine that a touch operation is detected at the display position of the side or the corner of the frame, when the touch operation is detected within a range of a first distance from a display position of the side or the corner of the frame; and
the controller is configured to change the first distance related to that side or that corner to a second distance larger than the first distance, when the side or the corner of the frame is located on the edge portion of the display area.

9. A control method of an electronic apparatus, comprising:
moving a side or a corner of a rectangular frame to an edge portion of a rectangular display area on a touch screen display, when the frame is displayed on the display area and when a first touch operation is detected at a display position of the side or the corner of the frame.

10. A computer-readable, non-transitory storage medium having stored thereon a computer program which is executable by a computer, the computer program controlling the computer to function as:
a controller configured to move a side or a corner of a rectangular frame to an edge portion of a rectangular display area on a touch screen display, when the frame is displayed on the display area and when a first touch operation is detected at a display position of the side or the corner of the frame.
